(19) United States
(12) Patent Application Publication
(10) Pub. No.: US 2003/0012396 A1
(43) Pub. Date: Jan. 16, 2003

(54) Headset

(76) Inventor: Anthony Henry Smith, Vienna (AT)

Correspondence Address: U.S. Philips Corporation, 580 White Plains Road, Tarrytown, NY, 10591, US

(21) Appl. No.: 10/099,679

(22) Filed: Mar. 15, 2002

(30) Foreign Application Priority Data
Mar. 20, 2001 (EP) 01201040.1

(51) Int. Cl. H04R 25/00

(52) U.S. Cl. 381/381

(57) ABSTRACT

The invention relates to a headset for reproducing audio signals. Headsets are known and used in combination with different types of (audio) apparatuses. The headset proposed by the invention enables the fixation of the coupling means at the central point of the headset. In this way the adjustment of the headset can be better optimized for each person.

The invention relates to a headset for reproducing audio signals.

The invention further relates to coupling means for use in a headset.

The invention further relates to an ear coupling part for use in a headset.

Headsets are known in the art and are used, for example, in combination with portable audio players, such as CD-players, MP3-players and others.

Current hands free headsets can only be adapted to the wide variety of human ear shapes and sizes by means of exchanging the ear hook.

Disadvantages of the known headsets are the lack of different solutions for mounting headsets, along with the great variety of human ear forms. This means that the user can experience discomfort and even reduced functionality of the product.

It is an object of the invention to improve the existing headsets.

To this end, a headset according to the invention comprises the features of claim 1.

None of the hands free headsets currently on the market, either with or without a cable, permit the headset to be mounted solely on the ear and at the same time provide a variety of mounting possibilities. The solution proposed with the headset according to the invention enables the fixation of the adapter at a central point.

Advantages of the headset according to the invention are a central attachment point, a possibility to rotate round the main axis of the attachment point and a possibility to slide the adapter in radial direction perpendicular to the rotation axis.

A headset having the above-mentioned features is much more reliable because the coupling means keep the headset in position also during bicycling, jogging, skating, etc.

Embodiments of the headset according to the invention comprise the features of the dependent claims.

Examples of an ear coupling part are an elastic ring, an ear clip, and an ear hook.

These and other aspects of the invention will be elucidated on the basis of the non-limiting examples as described hereinafter on the basis of the Figures. Herein shows:

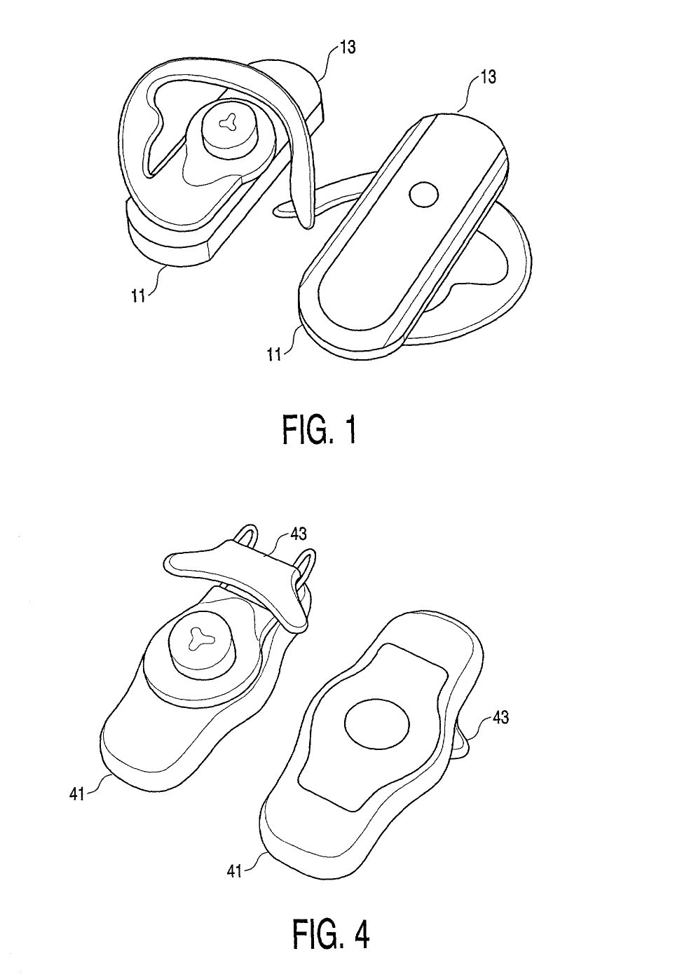

FIG. 1 a first example of a headset according to the invention,

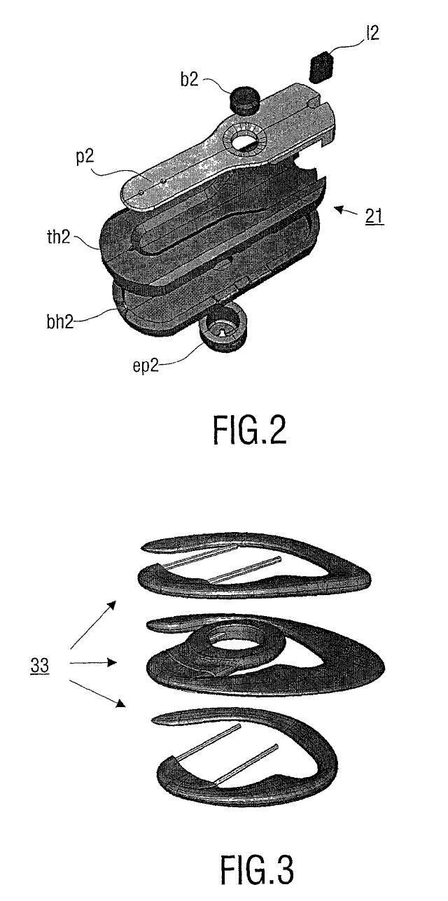

FIG. 2 a speaker element for use in a headset according to the invention,

FIG. 3 examples of an ear coupling part according to the invention,

FIG. 4 a second example of a headset according to the invention,

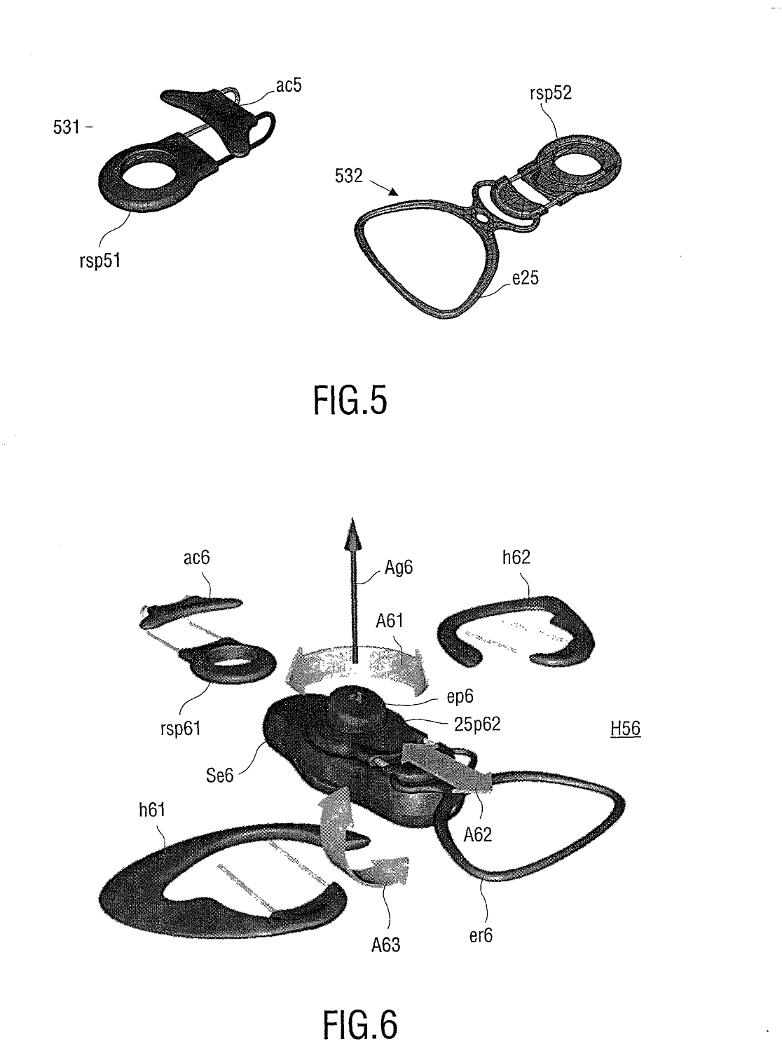

FIG. 5 a speaker element for use in a headset according to FIG. 4, and

FIG. 6 an ear coupling part of a headset according to the invention.

FIG. 1 shows a first example of a headset HS1 according to the invention, having a speaker element 11 and coupling means 13. In this example the coupling means comprise a ring-shaped part coupled around a loudspeaker of the speaker element, and an ear coupling part (in this example in the form of a hook, see FIG. 3 for more details of the hook).

FIG. 2 shows the speaker element 21 according to FIG. 1 (reference numeral 11) in more detail. The speaker element comprises in this example a top housing th, a bottom housing bh2, a plate p2, a button b2, a led l2 and an ear plug ep2.

FIG. 3 shows three examples of an ear coupling part of the coupling means in the form of a hook 33 according to the invention.

FIG. 4 shows a second example of a headset HS4 according to the invention, comprising a speaker element 41 and coupling means 43. In this example the coupling means comprise a ring-shaped part coupled around a loudspeaker of the speaker element. The ear coupling part is in this example in the form of an adjustable clip (see FIG. 5 for more details).

FIG. 5 shows coupling means of the headset according to FIG. 4 in more detail, whereby coupling means 531 comprises a ring-shape part rsp51 for coupling the coupling means around the speaker element and an adjustable clip ac5 to be coupled behind an ear. Coupling means 532 shows an elastic ring er5 to be coupled around an ear and a ring-shaped part rsp52 to be coupled around the speaker element.

FIG. 6 shows the operation of an example of a headset HS6 according to the invention in more detail.

A speaker element se6 comprising an ear plug ep6, with around it a ring shaped part rsp62 (resp. rsp61). In the shown situation the ear coupling part is in the form of an elastic ring er6, which can be adjusted by pushing and or turning it in the direction of the arrows respectively A61, A62 and A63.

The arrow AG6 shows the axis of the center of gravity, which passes through the center of the earplug and directly into the ear canal.

Instead of the elastic ring the hook h61 or h62 can also be connected to the ring shaped part rsp62.

Instead of the ring shaped part rso62 also the ring shaped part rsp61 can be coupled around the ear plug ep6.

Above headset according to the invention has been described on the basis of some examples. The man skilled in the art will be well aware of variations on these examples within the scope of the invention.

1. Headset for reproducing audio signals comprising a speaker element for processing and/or reproducing audio signals, coupling means for coupling the headset to an ear of the user, which coupling means comprise a ring-shaped part coupled around a loudspeaker of the speaker element of the headset and an ear coupling part.

2. Headset as claimed in claim 1, characterized in that the ear coupling part comprises an elastic ring to be coupled around an ear.

3. Headset as claimed in claim 1, characterized in that the ear coupling part comprises an adjustable clip to be coupled behind an ear.

4. Headset as claimed in claim 1, characterized in that the ear coupling part comprises a hook to be coupled behind an ear.

5. Coupling means for use in a headset as claimed in claim 1.

6. Ear coupling part for use in a headset as claimed in claim 1.
